(19) United States
(12) Patent Application Publication
(10) Pub. No.: US 2010/0268505 A1
(43) Pub. Date: Oct. 21, 2010

(54) METHOD AND APPARATUS FOR CONTROLLING IMAGE DATA ACQUISITION USING A MEASUREMENT PROGRAM PACKAGE

(76) Inventors: Christof Krellmann, Erlangen (DE); Mike Mueller, Moehrendorf (DE); Dani Sikiric, Erlangen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/763,297

(22) Filed: Apr. 20, 2010

(30) Foreign Application Priority Data
Apr. 20, 2009 (DE) 10 2009 018 062.1

(51) Int. Cl. G06F 19/00

(52) U.S. Cl. 702/108

(57) ABSTRACT

In a method to control the image acquisition and/or image evaluation at an image acquisition device, a measurement program of a measurement program package has at least one protocol step for measurement data acquisition according to a measurement protocol is used to operate the image acquisition device. At least one action element associated with the measurement program or at least one step is provided that causes an external, auxiliary program to be executed automatically upon occurrence of a trigger event in the measurement program or in the associated step.

### BACKGROUND OF THE INVENTION

1. Field of the Invention

The present invention concerns a method to control the image acquisition and/or image evaluation at an image acquisition device, in particular a magnetic resonance system, wherein a measurement program (realized in a measurement program package) that includes at least one protocol step for measurement data acquisition according to a measurement protocol is used.

2. Description of the Prior Art

Control methods of the above type that use a measurement program are known in the field of magnetic resonance and serve to conduct an examination of a patient with an image acquisition device as optimally as possible. Such measurement programs (also known as organ programs, for example) are largely executed automatically, wherein additional information can be input by users if necessary.

The core of such control methods is formed by protocol steps that describe measurement tasks and are executed successively by the image acquisition device, meaning that measurement data representing images are acquired from a subject. Each of these protocol steps is typically planned independently in advance, and additional steps in the method workflow (for example pause steps) can be inserted in order to administer contrast agent, for example.

A sequential, semi-automatic execution of the measurement program thus occurs in systems currently in use. Measurements and planning activities—for example the adaptation of the field of view—are thereby entered into the protocol in series. Control actions (that can be repeated multiple times per operating step) take place for the planning steps. The primary task of a user is to conduct an adaptation of acquisition parameters to the patient for all measurements of the examination, in particular the magnetic resonance examination.

Tendencies exist to replace these largely manual procedures with automated procedures of the most varied type, for example to achieve an automatic adaptation of the field of view or to evaluate physiological data of the patient in relation to the measurement. However, for this purpose the entire measurement program package that includes the measurement program must be revised in order to then be provided to the customer in a new version, although the customer perhaps does not need this special, newly implemented function at all.

### SUMMARY OF THE INVENTION

An object of the present invention is to provide a control method that allows an optimally standardized (in particular user-definable) use of additional automatisms in the measurement program.

This object is achieved in accordance with the invention in a method of the aforementioned type wherein at least one action element associated with the measurement program or at least one step is provided in which an external, auxiliary program is executed automatically upon the occurrence of a trigger event in the measurement program or in the associated step.

The invention makes use of action elements in the workflow of a measurement program or associated with a specific step, which action elements are not executed at a fixed time position of the measurement program—as this would be typical in the known, sequential workflow of the measurement program—but rather are only active given trigger events in order to then conduct a specific (in particular automated) function by means of an external auxiliary program (thus an auxiliary program that is not integrated into the measurement program package). Such an action element thus performs a specific functionality (in particular a functionality to be automated), for example the calculation of the field of view, and awaits a trigger event. The action element thus provides the possibility (option) to configure an item of the type known as a plugin, but that is integrated into the workflow defined by the measurement program. The auxiliary program can thus be provided as a DLL, for example, which can be addressed via a defined interface.

The action elements are added in advance by the user and configured and executed automatically during the workflow of the measurement program upon occurrence of the trigger event. The measurement program package thus executes its individual steps sequentially, as is known, with the action element (consequently the auxiliary program) being executed upon the occurrence of a configured trigger event. The action element is preferably inserted into the measurement program as an additional step upon occurrence of the trigger event, meaning that the remaining measurement program is halted until the auxiliary program is executed. It is also possible for the auxiliary program to run in parallel with the execution of the steps of the measurement program.

The action elements provided according to the invention thus allow the flexible integration of tasks (in particular tasks to be automated) through the auxiliary program that requires no operator interactions, so that recurring tasks (from a user point of view) such as the adaptation of the examination to the anatomy of the patient can be implemented automatically by the action elements. This achieves a time savings and a reduction of the possible operator errors. The user can better concentrate on his or her primary task, namely the examination. The inclusion of automated procedures by the user, and thus a high flexibility of the workflow, thus results (in particular in the advantageous case of an auxiliary program requiring no operator interaction) through the temporal connection of action elements with the present, already known, normal steps of the measurement program (for example protocol and pause steps) within the examination workflow.

A further advantage achieved by the method according to the invention is a decoupling of the measurement program package and additional tasks (in particular tasks to be automated) in the form of the auxiliary program. A clearly defined interface exists between the measurement program package and the auxiliary program, such that it is possible to deliver the auxiliary program (which consequently corresponds to plugins) to a customer later, after delivery of the measurement program package, without any problems. The auxiliary program must merely be copied onto the system, for example in the form of a DLL. Since the functionality of the action elements is already contained in the measurement program package and the user can thus configure action elements, the measurement program itself does not have to be altered. An (in particular automated) additional functionality can consequently be added without a system change, even without shutting down the system.

Action elements can be associated with the entire measurement program, thus be initiated at any point in time in the workflow of the measurement program upon the occurrence of a trigger event, but it is also possible to associate action elements with only at least one specific step of the measurement program, for example a specific protocol step. The auxiliary program is then executed only during this specific step of the measurement program upon the occurrence of the trigger event. A high flexibility of the application, in particular with regard to automatic auxiliary functions, is created in this way.

Naturally, it is also possible for at least one parameter to be passed by the measurement program package to the auxiliary program means and/or the measurement program package can receive at least one parameter (in particular a parameter affecting the further workflow of the measurement program) from the auxiliary program. The action element thus can be configured not only as to when (thus at which trigger event) the auxiliary program can be executed, but also as to which specific variables or the like that the auxiliary program requires for its task are passed to the auxiliary program. For example, if the auxiliary program loads images in a graphic segment, parameters/variables can be passed along as well that indicate which images should be loaded in which graphic segment. The auxiliary program can similarly return specific parameters or variables to the measurement program package, for example if a field of view is automatically determined and the parameters defining the field of view are required in the further workflow (for example in the following protocol step).

As mentioned, an action element can be added to the measurement program or a step thereof and/or can be configured by a user. The user thus determines which automations or other extensions should be integrated in which way into the workflow of the measurement program. In particular, an action element can be added via an operating unit of a user interface that defines the properties of the measurement program or a step thereof. If the user interface is provided with windows, a slider in which action elements can be creatable and/or configurable can be provided, for example in a window to adjust the properties of the measurement program or a step of the measurement program. Naturally, other possibilities are possible as to how the addition and/or configuration of action elements can be conducted by a user in the user interface.

It is also possible for an action element to be added and configured automatically in an automatically configured measurement program. In part, the order for examination (which, for example, can originate from an information system, in particular a radiology information system or a hospital information system) already provides sufficient information in order to allow the reasonable usage of a few action elements. At least one action element can then be added and configured automatically given an automatic creation and configuration of the measurement program.

The flexibility of the control method described herein can particularly advantageously be increased further by using at least one action element with at least two trigger events. Then different auxiliary programs of an auxiliary program package and/or different parameters to be passed to the auxiliary program package, these different programs or parameters associated with different trigger events of an action element. This further increases the flexibility since, for example, automatisms (for example automatisms that are connected in terms of content and that are to be added) can be combined into groups and can be realized in a single action element. In particular, it can then also be provided that the auxiliary program package forms a single file (in particular a single DLL) so that ultimately plugin packages can be assembled.

There are a number of possibilities for the design and functionality of the auxiliary program since in particular an automation or even a realization of functionalities outside of the measurement program package is useful at many points. Examples are a program implementing an evaluation and/or processing of image data; and/or a program activating and/or reading out the image acquisition device and/or additional devices that are used; and/or a program determining and/or checking an acquisition parameter; and/or a program affecting or altering the additional workflow of the measurement program. In addition to the aforementioned automated adaptation of the field of view and the automatic loading of acquired images in specific user interfaces, complex calculations—for example slice positionings, the collection and the evaluation of patient measurement data (for example EKG values), the automatic use of this information in the acquisition parameters (automatic capture cycle), filterings, adaptations of the presentation, marking of aids in acquired images, consistency checks of acquisition parameters, the determination of specific times in contrast agent examinations and the like—are also possible.

In addition to the aforementioned protocol and pause steps, user interaction steps are also possible as “conventional” steps (thus steps that are to be executed sequentially) of the measurement program. While the workflow of the measurement program has previously been realized rather rigidly and the configuration previously had to be implemented in advance or in separate user interfaces, such steps enable an additional optimization and adaptation of the measurement program. For example, a planning step for adjustment on the part of the operator of acquisition parameters of at least one following program step; and/or an evaluation step to evaluate measurement data acquired in a preceding protocol step using an evaluation algorithm, and for adjustment on the part of the operator of acquisition parameters of at least one following protocol step depending on the evaluation result; and/or a decision step for decision on the part of the operator about the additional method workflow (for example for selection of at least one method segment comprising at least one additional program step) can be used as operator interaction step. A plurality of possibilities is also conceivable.

In addition to the method, the present invention also concerns an image acquisition device, in particular a magnetic resonance system that is fashioned for the implementation of the method according to the invention. A control device is provided that controls the operation of the image acquisition device according to a measurement program, wherein the image acquisition device also has an operating device with a display device and an input device. All embodiments with regard to the method according to the invention are applicable to the image acquisition device (in particular magnetic resonance system) according to the invention.

### BRIEF DESCRIPTION OF THE DRAWINGS

FIG. 1 shows a magnetic resonance system according to the invention.

FIG. 2 is a flowchart of an embodiment of the method according to the invention.

FIG. 3 shows an example of a user interface for adaptation of the measurement program according to the invention.

### DESCRIPTION OF THE PREFERRED EMBODIMENTS

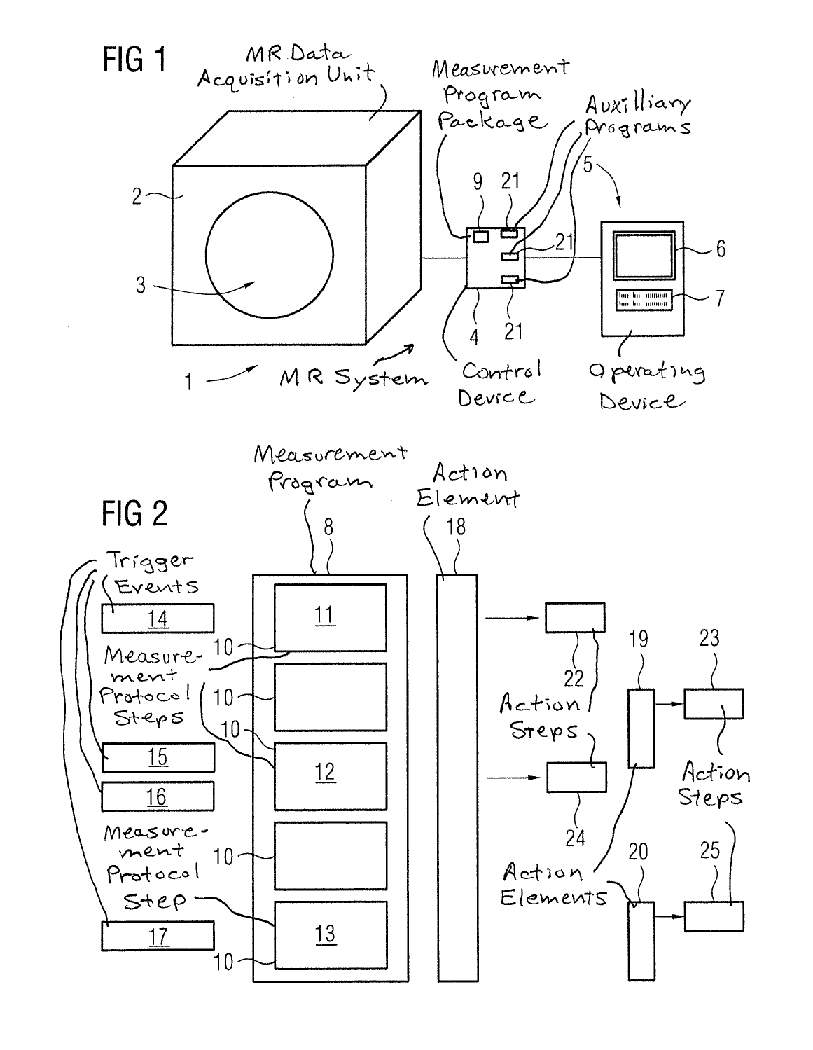

FIG. 1 shows a magnetic resonance (MR) system 1 according to the invention. It has an MR data acquisition unit (scanner) 2 in which a patient can be inserted into a patient receptacle 3. The design of the data acquisition unit 2 with a basic field magnet, gradient coils, radio-frequency coils and the like is generally known and need not be depicted in detail herein.

In addition to a control device 4 to control the magnetic resonance system, the magnetic resonance system has an operating device 5 that contains a display device 6 and an input device 7 via which a measurement program to control the magnetic resonance system 1 can be created and configured. The magnetic resonance system 1 is fashioned to implement the method according to the invention, which should be presented in detail in the following with reference to FIG. 2.

The core of the method according to the invention is a measurement program 8 that is realized by a measurement program package 9 stored in the control device 4. As is known, it contains the sequential sequence of different steps 10 that, for example, can be protocol steps, pause steps or operator interaction steps. In the present example, in particular the protocol steps 11, 12 and 13 should be considered in detail.

However, it is noted that trigger events (for example the opening of a measurement protocol, the beginning of a measurement, the activation of components, the beginning and the end of an image reconstruction and the like) can occur in the workflow of the measurement program 8. Exemplary trigger events 14, 15, 16 and 17 are shown to the left of the measurement program 8 in FIG. 2.

In the shown exemplary embodiment, three action elements 18, 19 and 20 are now provided in addition to the typical steps 10 of the measurement program 8. While the action element 18 is associated with the entire measurement program 8, the action elements 19 and 20 are respectively associated only with the steps 12 and 13. The action elements 18 serve to integrate auxiliary functions (which are realized by an auxiliary program 21 stored in the control device 4) into the workflow of the measurement program 8 such that the auxiliary program means (likewise with parameters predetermined by the action elements 18, 19, 20) to be recalled given the occurrence of specific trigger events, for example one of the trigger events 14-17. The execution of the measurement program 8 or the directly running step 10 is consequently halted in order to allow the implementation of the auxiliary program, which corresponds to action steps 22-25. These run completely without user interactions, meaning that automatisms that are not contained in the measurement program package 9 are realized by them. The auxiliary program 21 can consequently be considered as a “plugin”. The plugin can naturally also return parameters affecting the further workflow of the measurement program 8 (and thus the control of the image acquisition device) to the measurement program package 9, which is explained in further detail via examples in the following.

The action elements 18, 19, 20 can be added to the measurement program 8 or, respectively, the corresponding steps and configured by a user, wherein in principle it is also conceivable that automatic action elements are also added and configured, in particular given automatic measurement programs created and configured based on orders of an information system. However, generally specific automatisms that are realized by the auxiliary program means 21 and, for example, pertain to the evaluation or determination of acquisition parameters, can be added by a user.

Step 11 of the measurement program 8 presently pertains to the acquisition of a localizer; step 12 concerns the acquisition of T1-weighted images and step 13 concerns the acquisition of T2-weighted images. The action element 18 now contains the configuration that specific, presently acquired images should be loaded into specific segments of a user interface—in particular be prepared in a specific manner, which can also be passed as parameters to the auxiliary program—by an auxiliary program 21 upon occurrence of the trigger event “image reconstruction ends”. The trigger events 14 and 16 correspond to such an ending of an image reconstruction so that an auxiliary program 21 is called upon occurrence of both events since the action element 18 is associated with the entire measurement program 8, which results in the creation of the action steps 22 and 24 that are incorporated into the workflow of the measurement program 8.

The action element 19 pertains to the determination or adaptation of the field of view. It is associated with the step 12 that is situated after the acquisition of the localizer images that serve as a basis for the automated adaptation, which in turn is realized via an auxiliary program 21 that should be recalled if the measurement program is opened in step 12. This is presently represented by the trigger event 15 so that an action step 23 that is incorporated into the workflow of the measurement program 8 is generated at this point in time via execution of the corresponding auxiliary program means 21 with the corresponding parameters. After the field of view is determined and/or adapted, corresponding acquisition parameters that can in particular affect the workflow of the acquisition ensuing in steps 12 and 13 are returned to the measurement program means 9 (and thus the measurement program 8). The use of the action elements consequently directly causes a modification of the control workflow, thus a modified control.

The action element 20 which is associated with the step 13 (in which a precise tuning with physiological measurements of the patient, in particular the EKG, is important) is discussed as a final example. Step 25 is consequently called at the trigger event 17, which in turns corresponds to the opening of the measurement program by the action element 20 of one of the program 21. For example, measurement data from an EKG device can be queried therein, and it can be checked whether the acquisition parameters are still compatible with the current frequency or must possibly be changed.

Clearly a great many possibilities and embodiments are conceivable for automatisms and functions that can be realized via action elements.

At this point it is noted again that an action element can include not only a trigger and/or a program to be executed; but also multiple different trigger events, for example, which are then associated with the same or different auxiliary programs so that related functions (for example) can be combined into a single action element.

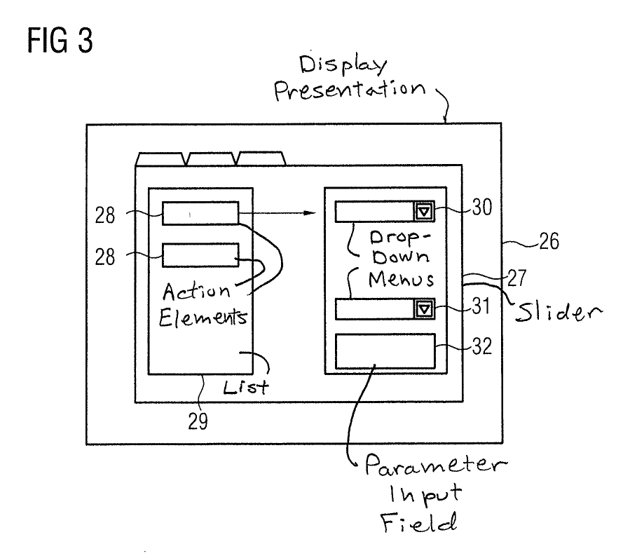

FIG. 3 shows an example of a display presentation 26 on the display device 6 via which the creation and configuration of an action element can ensue. It is assumed that the user has retrieved the properties of the measurement program 8 or a step 10 via a corresponding operator action. Action elements 28 (that can, for example, be displayed in a list 29) can now be created and/or configured in a slider 27. Therefore drop-down menus 30, 31 for the trigger events or the auxiliary program to be executed are shown as examples, as well as an input field 32 for parameters to be transferred and/or to be received.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for controlling acquisition of image data using an image acquisition device that interacts with a subject from which the image data are acquired, comprising the steps of:
operating said image acquisition device from a computerized control unit according to a measurement program package installed in said computerized control unit, said measurement program package comprising a measurement program that includes at least one protocol step for acquisition of measurement data from the subject according to a measurement protocol;
providing said computerized control unit with an action element associated with said measurement program or said at least one protocol step;
in said computerized control unit, detecting occurrence of a predetermined trigger event, associated with said action element, in said measurement program or in said at least one protocol step; and
upon detection of said occurrence of said predetermined trigger event by said computerized control unit, automatically causing an external, auxiliary program, designated by said action element, to be executed in the measurement program or in said at least one protocol step.

2. A method as claimed in claim 1 comprising halting said measurement program while said auxiliary program is executed.

3. A method as claimed in claim 1 comprising triggering and executing said auxiliary program through said action element with no manual interaction with said computerized control unit.

4. A method as claimed in claim 1 comprising passing at least one parameter between said auxiliary program and said measurement program.

5. A method as claimed in claim 1 comprising passing a parameter that affects workflow of said measurement program from said auxiliary program from said auxiliary program to said measurement program.

6. A method as claimed in claim 1 comprising manually adding said action element to said measurement program in said measurement program package.

7. A method as claimed in claim 1 comprising configuring said measurement program package to embed said action element therein.

8. A method as claimed in claim 1 comprising automatically configuring said measurement program package including automatically configuring or adding said action element in the automatically configured measurement program.

9. A method as claimed in claim 1 comprising providing at least two predetermined trigger events that each trigger at least one action element.

10. A method as claimed in claim 9 comprising associating a different auxiliary program with different action elements that are respectively triggered by said at least two trigger events.

11. A method as claimed in claim 9 comprising passing different parameters between said auxiliary program and said measurement program respectively upon the occurrence of said at least two trigger events.

12. A method as claimed in claim 1 comprising selecting said auxiliary program from the group consisting of programs implementing evaluation of image data, programs implementing processing of image data, programs activating said image acquisition device, programs for reading out said image acquisition device, programs for activating additional devices operating in combination with said image acquisition device, programs for reading out an additional device operating in combination with said image acquisition device, programs for determining an acquisition parameter associated with image acquisition in said image acquisition device, programs for checking an acquisition parameter associated with image acquisition in said image acquisition device, and programs that modify workflow in said measurement program.

13. A method as claimed in claim 1 wherein said measurement program comprises a pause step that is affected by execution of said auxiliary program.

14. A method as claimed in claim 1 wherein said measurement program comprises a operator interaction step that is affected by execution of said auxiliary program.

15. An image data acquisition system comprising:
an image data acquisition unit that interacts with a subject from which the image data are acquired;
a computerized control unit configured to operate said image data acquisition unit according to a measurement program package installed in said computerized control unit, said measurement program package comprising a measurement program that includes at least one protocol step for acquisition of measurement data from the subject according to a measurement protocol;
an input providing said computerized control unit with an action element associated with said measurement program or said at least one protocol step; and
said computerized control unit being configured to detect occurrence of a predetermined trigger event, associated with said action element, in said measurement program or in said at least one protocol step, and upon detection of said occurrence of said predetermined trigger event, to automatically cause an external, auxiliary program, designated by said action element, to be executed in the measurement program or in said at least one protocol step.
